(19) United States
(12) Patent Application Publication
(10) Pub. No.: US 2013/0302545 A1
(43) Pub. Date: Nov. 14, 2013

(54) WORKPIECE PART AND METHOD FOR CONNECTING WORKPIECE PARTS BY LASER BEAMS

(71) Applicants: Franz-Josef Schnelker, Neuss (DE); Werner Buse, Kaarst (DE); Rolf Dohrmann, Kaarst (DE); Alvito Fernandes, Leverkusen (DE)

(72) Inventors: Franz-Josef Schnelker, Neuss (DE); Werner Buse, Kaarst (DE); Rolf Dohrmann, Kaarst (DE); Alvito Fernandes, Leverkusen (DE)

(73) Assignee: PIERBURG GmbH, Neuss (DE)

(21) Appl. No.: 13/979,657

(22) PCT Filed: Jan. 11, 2012
(86) PCT No.: PCT/EP2012/050363

§ 371 Date: Jul. 15, 2013

(30) Foreign Application Priority Data
Feb. 2, 2011 (DE) 10 2011 010 181.0

(51) Int. Cl. B23K 26/00; F16K 27/00; B29C 65/14

(52) U.S. Cl. CPC B23K 26/0063; B29C 65/1403; F16K 27/00
USPC 428/34.1; 156/272.8; 428/99; 219/121.64

(57) ABSTRACT

A workpiece part for a housing assembly for connecting two workpiece parts via a joining zone includes a laser beam-absorbing material, and at least one rib element arranged in the joining zone.

### CROSS REFERENCE TO PRIOR APPLICATIONS

This application is a U.S. National Phase application under 35 U.S.C. §371 of International Application No. PCT/EP2012/050363, filed on Jan. 11, 2012 and which claims benefit to German Patent Application No. 10 2011 010 181.0, filed on Feb. 2, 2011. The International Application was published in German on Aug. 9, 2012 as WO 2012/104117 A2 under PCT Article 21(2).

### FIELD

The present invention relates to a workpiece part, in particular, for housing assemblies of, for example, pumps, valves, and the like, in which two workpiece parts can be connected by a joining zone, wherein the workpiece part comprises a laser beam-absorbing material. The present invention further relates to a method for connecting, by means of laser beams, workpiece parts which in particular belong to a housing assembly, for example, for pumps, valves and the like, wherein a first laser beam-transparent workpiece part and a second laser beam-absorbing workpiece part are connected to each other by a joining zone such that the laser beams of a laser beam source are introduced through the first workpiece part and that the second workpiece part is heated in the region of the joining zone in such a manner that the second workpiece part and the first workpiece part attain a fusible state in the joining zone and, during subsequent cooling, a solidification of the joining zone is achieved.

### BACKGROUND

Such a workpiece part as well as such a method for connection by means of laser beams is described in EP 0 751 865 B2. EP 0 751 865 B2 proposes applying a pressure application in the region of the joining zone during and after the heating and the fusing treatment of the joining zone by the laser beams in order to improve welding quality. This pressure application will in particular be performed by hydraulic, pneumatic or by roll-like hold-down devices which, if required, can be transparent. It should be evident that an apparatus for performing the welding method by use of such hold-down devices involves a high manufacturing expenditure. Practicing such a method is correspondingly expensive.

### SUMMARY

An aspect of the present invention is to provide a workpiece part and a method which avoid the aforementioned disadvantages.

In an embodiment, the present invention provides a workpiece part for a housing assembly for connecting two workpiece parts via a joining zone which includes a laser beam-absorbing material, and at least one rib element arranged in the joining zone.

### BRIEF DESCRIPTION OF THE DRAWINGS

The present invention is described in greater detail below on the basis of embodiments and of the drawings in which:

FIG. 1 shows a sectional view of a solenoid valve comprising a workpiece part according to the present invention;

FIG. 2 shows a schematic sectional view of two workpiece parts shifted into each other; and

FIG. 3 shows a schematic partial view of an embodiment of two interconnected workpiece parts.

### DETAILED DESCRIPTION

In an embodiment of the present invention, a workpiece part is provided which, in the region of the joining zone, comprises at least one rib element. In this manner, when the two workpiece parts are being joined, a pressure effect will be generated by a build-up of interior stresses in the two parts. Application of an external pressure effect by provision of hydraulic, pneumatic or roll-like hold-down devices is no longer required. A particularly uniform pressure effect will be generated if a surrounding rib element is provided. It is further advantageous if, in the region of the rib element, at least one expulsion surface in the form of a groove or knurling is provided.

The laser beam-absorbing workpiece part can be made of plastic or, also, of metal.

In an embodiment of the present invention, a method for connecting workpiece parts by means of laser beams is provided, wherein, in the initial state, the second workpiece part comprises at least one rib element such that the two workpiece parts are transferred into a press fit in a first step to create a press region in the joining zone, and, in a second step, the two workpiece parts are non-positively and/or positively connected to each other in the joining zone by the connection performed by means of laser beams. In this regard, for achieving a uniform pressure introduction, it is can be advantageous if the rib element is provided as a surrounding rib element, such that the joining zone and the press region coincide.

It is further of advantage if, in the press region, at least one expulsion surface, for example, in the form of a groove or knurling, is provided so that, after connection, the press region will be dissolved and the inner stresses will be reduced.

An embodiment of the present invention is illustrated in the drawing and will be described hereunder.

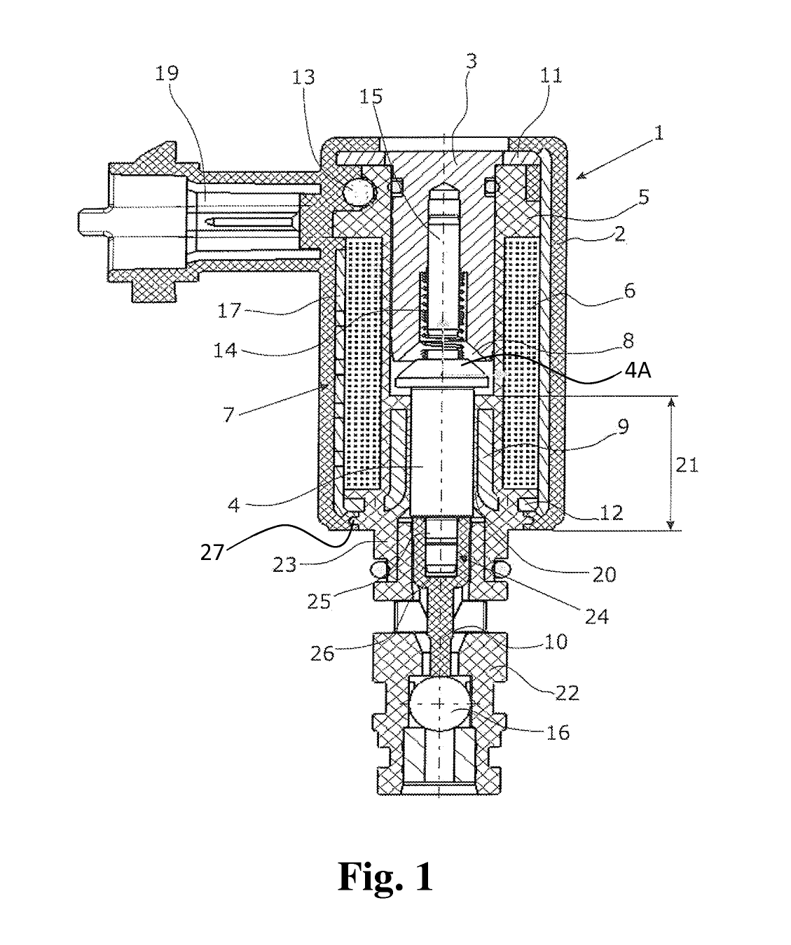

FIG. 1 illustrates, in sectional view, a solenoid valve 1 according to the present invention, the valve being used as an oil pressure control valve. Solenoid valve 1 comprises a housing 2 accommodating therein a core 3, an armature part 4, a coil former 5 having a coil 6 wound thereon, and a return-path arrangement 7. In the present case, the armature part 4 is connected, through a plug-in connection 24, to a plunger member 10 acting in a known manner onto a valve closure element 16. In this arrangement, plunger member 10 is guided to run in a valve sleeve 22 which is formed as a laser-beam-absorbent workpiece part and which is inserted in a receiving bush 23 formed on a side of coil former 5 opposite to core 3, the receiving bush 23 being integrally connected to coil former 5 and being formed as a laser-beam-transparent workpiece part. Valve sleeve 22 and receiving bush 23 are connected to each other by laser-beam welding.

A solenoid valve of the above type, which is known in its functionality, operates as follows: In the deenergized state, a gap 8 exists between armature part 4 and core 3, in which, when coil 6 is energized, a magnetic field is generated that will entail an axial movement of armature part 4. The plunger member 10, connected to armature part 4, will also be correspondingly moved and the valve closure element 16 will be released.

In the present exemplary embodiment, a return-path inner section 9 is formed integrally with the return-path cover section 12 facing away from core 3 and is integrated in coil former 5. During manufacture of coil former 5, the return-path inner section 9 and the return path cover section 12 have been encapsulated by use of an injection molding method. It is further provided that an interference suppression resistance 13 has already been integrated in coil former 5. In this manner, essential components can be installed in the coil former 5 during pre-assembly. During manufacture of a standard coil component, it will then be merely required to select the coil 6 for the valve function and to mount it on the coil former 5. After the second return-path cover section 11 has been placed and the return-path side portion 17 has been brought into a press connection with the return-path cover sections 11,12 so as to allow an electromagnetic circuit to be generated, and after the contact with an electrical plug 19 has been established, the solenoid valve 1 will be finished by being overmolded with the outer housing 2 around it. In doing so, there will be provided, between outer housing 2 and coil former 5, a contour creating a kind of labyrinth-like seal 27 for increasing the sealing effect toward the atmosphere.

In the present case, the solenoid valve will then be completed by installation of the core 3, the armature part 4 and the associated components such as, for example, a spring 14 that, in the present case, keeps the armature part 4 under a biasing force, as well as a stop pin 15 adjustably arranged in the core 3. In the process, it is helpful for the positioning if a portion of core 3 opposite from armature part 4 has a larger diameter than a portion of coil former 5 opposite from valve closure element 16.

In the present exemplary embodiment, bearing means 20 for armature part 4 are formed by coil former 5, wherein the bearing region 21 substantially coincides with the region in which the return path inner section 9 is provided. This embodiment is rendered possible in that a first portion 4a, facing toward the core, of armature part 4 has a larger diameter than the inner diameter of a portion 21 of coil former 5. In addition to the considerable benefit for the assembly process, this design offers the advantage that the bearing portion 21 of coil former 5 is positively reinforced by the insertion of the return path inner section 9. Applying a sliding layer in the bearing portion 21 will allow for optimum resistance-free slidability of armature part 4 in the coil former 5. Coaxial guidance of armature part 4 in the solenoid valve is provided by the dual function of coil former 5 which, on the one hand, takes up the core 3 and, on the other hand, functions as bearing means for armature part 4. It is of course also possible to provide a bearing bushing, not illustrated in detail herein, in bearing region 21.

For final assembly, all that is required is to plug onto the armature part 4 the plunger member 10 chosen for the valve function, thus producing a plug-in connection 24. For this purpose, the armature part 4 comprises a pin 25 which is adapted to be inserted into a recess 26 in the valve plunger 10 and which is thus connected with the latter by force-fit or form-fit. The pin 25 may here further comprise a knurling, not illustrated in detail, by which the height of stroke can be adjusted. In the present exemplary embodiment, the plunger member 10 will be mounted during final assembly together with the valve sleeve 22.

Coaxiality errors can be reduced since, in this case, a part of the coil former 5 is formed as a receiving bush 23 for the valve sleeve 22. As provided according to the present invention (see also FIG. 2), the valve sleeve 22 comprises, as a second laser-beam absorbing workpiece part, a surrounding rib element 28, thus generating a press fit upon insertion into the receiving bush 23.

FIG. 2 is a schematic detailed view of the workpiece parts plugged into each other, these being, in the present case, the valve sleeve 22 and the receiving bush 23. In the upper right-hand part of FIG. 2, there is illustrated the state of the two workpiece parts prior to connection by laser-beam welding. The laser-beam absorbing workpiece part, the valve sleeve 22, comprises a surrounding rib element 28 at whose upper and lower sides a respective groove 29,30 is provided which during the welding process serves as an expulsion surface for the material of rib element 28. Since the rib element 28 is provided as a surrounding rib element 28, the joining zone 31 during the laser-welding process and the press region coincide with each other. The lower right-hand part of FIG. 2 illustrates the situation in the joining zone 31 after the laser-welding treatment. It is clearly visible that the rib element 28 has largely dissolved. During the laser-beam process, the laser beam in this case will pass, from the outside, through the first workpiece part, the receiving bush 23, and will in the joining zone 31 impinge on the rib element 28 which then will be liquefied and thus produce a connection between the two workpiece parts, wherein, during the joining process, the inner stresses will be reduced and the material of the liquefied rib element 28 will be expelled into the grooves 29 and 30 provided for this purpose.

It has proven advantageous to size the excess diameter of the rib element 28 to the effect that the inner stresses in both component parts will not exceed the allowable height, which is to say that the maximum stretchability for plastic materials will be complied with.

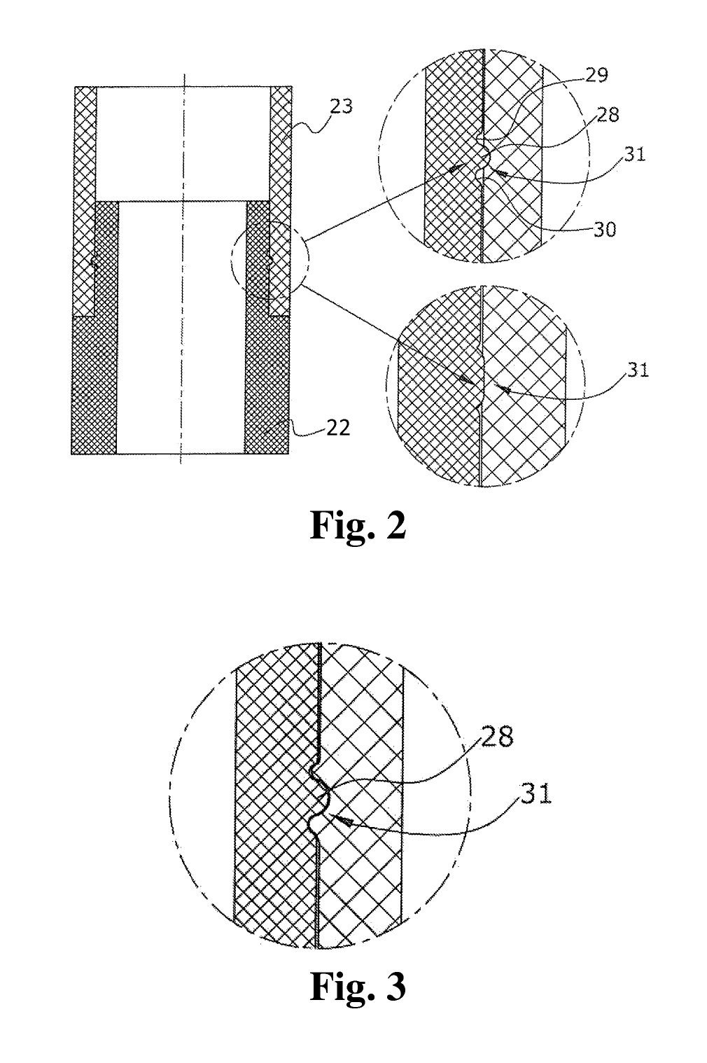

It is also possible, however, to use metal as the laser-beam-absorbing material. In this case, the heating of the joining zone 31 will result merely in a melt-like state of the first workpiece part in the joining zone 31. The rib element 28 of the second laser-beam-absorbing workpiece part will substantially continue to exist, as schematically depicted in FIG. 3. After cool-down and solidification of the joining zone 31, a positive connection will have been established in this manner.

The rib element 28 can additionally also take shapes different from the one shown for the present embodiment. It is also of course conceivable that expulsion surfaces are provided in the laser-beam-transparent workpiece part.

The present invention is not limited to embodiments described herein; reference should be had to the appended claims.

What is claimed is:

1-8. (canceled)

9. A workpiece part for a housing assembly for connecting two workpiece parts via a joining zone, the workpiece part comprising:
a laser beam-absorbing material; and
at least one rib element arranged in the joining zone.

10. The workpiece part as recited in claim 9, further comprising a circumerential rib element.

11. The workpiece part as recited in claim 9, further comprising at least one expulsion surface in the form of a groove or a knurling disposed in a region of the at least one rib element.

12. The workpiece as recited in claim 9, wherein the laser beam-absorbing material is a plastic.

13. The workpiece part as recited in claim 9, wherein the laser beam-absorbing material is a metal.

14. The workpiece part as recited in claim 9, wherein the housing assembly is of a pump or a valve.

15. A method for connecting a first workpiece part with a second workpiece part via a laser beam, the method comprising:
providing the first workpiece part comprising a first material which is transparent for a laser beam;
providing the second workpiece part comprising at least one rib element and a second material which absorbs the laser beam, the first workpiece part and the second workpiece part being configured to be connected via a joining zone;
press-fitting the first workpiece part with the second workpiece part together via the at least one rib element so as to provide a press region in the joining zone;
providing the laser beam from a laser beam source;
introducing the laser beam through the first workpiece part into the second workpiece part; thereby,
heating the second workpiece part in a region of the joining zone so that at least one of the second workpiece part and the first workpiece part attain a liquid-melted state in the joining zone; and thereafter
cooling and solidifying the heated region of the joining zone so as to obtain a solidified joining zone and at least one of a force fitting and a form fitting of the first workpiece part with the second workpiece part in the joining zone.

16. The method as recited in claim 15, wherein the at least one rib element is provided as a circumferential rib element so that the joining zone and the press region coincide.

17. The method as recited in claim 15, wherein the second workpiece part further comprises at least one expulsion surface in the press region in a form of a groove or a knurling so that, after the at least one of a force fitting and a form fitting, the press region is dissolved and inner stresses are reduced.

18. The method as recited in claim 15, wherein the first workpiece part and the second workpiece part belong to a housing assembly of a pump or a valve.
